(19) United States
(12) Patent Application Publication
(10) Pub. No.: US 2015/0228027 A1
(43) Pub. Date: Aug. 13, 2015

(54) METHOD FOR FACILITATING CROWD-INVESTING

(71) Applicant: Jonathan Block, New York, NY (US)

(72) Inventor: Jonathan Block, New York, NY (US)

(21) Appl. No.: 14/621,693

(22) Filed: Feb. 13, 2015

Related U.S. Application Data
(60) Provisional application No. 61/939,448, filed on Feb. 13, 2014.
(60) Provisional application No. 62/106,964, filed on Jan. 23, 2015.

(51) Int. Cl. G06Q 40/06

(52) U.S. Cl. CPC G06Q 40/06

(57) ABSTRACT

A method of facilitating crowd-investing of at least one investor in a venture offered by a crowd-investing server. The method includes receiving an interest communication electronically communicated to the crowd-investing server from an investor computing device associated with the investor. The interest communication indicates an interest of the investor to be qualified with the crowd-investing server for investment in any current or future ventures offered by the crowd-investing server. A designated code is established by the crowd-investing server at which to receive the interest communication sent from the investor computing device. Further, a designated phrase is established by the crowd-investing server for inclusion in the interest communication to allow the crowd-investing server to automatically recognize an interest of the investor to be qualified with the crowd-investing server. The designated code and designated phrase are presented to the investor prior to the step of receiving the interest communication.

### CROSS REFERENCE TO RELATED APPLICATION

This application claims the benefit of U.S. Patent Application Ser. No. 61/939,448 filed on Feb. 13, 2014 and U.S. Patent Application Ser. No. 62/106,964 filed on Jan. 23, 2015, the entire disclosures of which are hereby incorporated by reference.

### BACKGROUND OF THE INVENTION

1. Field of the Invention

A method of facilitating crowd-investing of at least one investor in a venture offered by a crowd-investing server.

2. Description of the Prior Art

The process of private equity investment in the venture capital industry includes the steps of an entrepreneur submitting a business plan for a company to produce a new product or service, technology and market information, a financial analysis of the prospects of the venture, and the amount sought with source and use of funds. The venture capital due diligence process analyzes the business, market potential, technology, management, and capital appreciation potential in order to make an investment decision. The decision-making has always been manual and almost always relies on the assessment of a few individuals within the venture firm who may or may not have subject matter expertise. Regardless, it has been shown that there is very little correlation between venture characteristics, entrepreneur capability, product/service and technology and the actual venture investment appreciation, and therefore, there is no predictable way to estimate the probability of success of a venture from an investment growth point of view. Thus, the prior art venture investment decision-making and evaluation is fairly manual, inefficient, not easily replicable, and has no dependable correlation to success factors.

Crowd-investing is a new way for entrepreneurs to present their venture directly to a crowd of individuals in order to attract small or different amounts of investment funding directly from a large number or group of these individuals in exchange for equity instruments such as equity shares, options, convertible debentures or other financial derivatives in and of the venture. This is unlike the traditional process of an entrepreneur pitching to a venture capitalist to raise a large sum of money from a single investment fund of the venture firm, and the firm making the ultimate decision as to whether to invest in the company through one of the funds they manage for their accredited investors.

Methods of facilitating crowd-investing of individual investors through a crowd-investing server are known in the art. One such method is disclosed in U.S. Patent Application Publication No. US 2014/0012780 to Aaron M. Sanders. The method includes the step of receiving information communicated to the crowd-investing server from the investor to qualify the investor to invest in ventures offered by the crowd-investing server. Such communications are limited to computer-based transaction platforms like email, and all mostly focused on ultimately recommending a business for investment.

Such known methods of facilitating crowd-investing suffer from certain drawbacks. Notably, there remains a need for improvements in the process of alerting potential investors to crowd-investing opportunities. Furthermore, after an investor has identified a venture in which they have an interest of crowd-investing, it can be a time-consuming and difficult process for the investor to even initially become registered and qualified with a crowd-investing server to crowd-invest in any of the ventures offered by the crowd-investing server.

### SUMMARY OF THE INVENTION

The subject method of facilitating crowd-investing includes receiving an interest communication electronically communicated or sent from an investor computing device to a designated code established by the crowd-investing server. The interest communication indicates an interest of the investor to be qualified with the crowd-investing server for investing in any current or future ventures offered by the crowd-investing server. Further, a designated phrase is established by the crowd-investing server for inclusion in the interest communication to allow the crowd-investing server to automatically recognize an interest of the investor to be qualified with the crowd-investing server. The designated code and designated phrase are presented to the potential investor prior to receiving the interest communication from the investor computing device.

### Advantages of the Invention

The invention in its broadest aspect provides for an improved process of alerting potential investors in crowd-investing opportunities, and an improved process of registering and qualifying the investors with a crowd-investing server so that they may crowd-invest in any venture offered by the crowd-investing server.

More specifically, since the investor is presented with a designated code at which to transmit an interest communication including the designated phrase, the investor is able to begin the process of becoming registered and qualified to crowd-invest as soon as they become aware of the venture. Said another way, the investor is advantageously able to transmit a “real-time” communication to the crowd-investing server communicating their interest to crowd-invest as they become aware of the crowd-investing opportunity.

Furthermore, because the designated phrase and designated code are simple in their presentment, they may be advantageously shown to investors by way of such mediums like television, radio and any other form of communication and media including mobile and web properties, and streaming and physical media, therefore making them readily viewable to a large number of investors.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a flow diagram of an embodiment of a method of facilitating crowd-investing of at least one investor in a venture offered by a crowd-investing server and illustrating a step of receiving an interest communication;

FIG. 2 is a flow diagram of an additional embodiment of a method of facilitating crowd-investing of at least one investor in a venture offered by a crowd-investing server and illustrating a step of receiving a notice communication; and

FIG. 3 is a flow diagram of an additional embodiment of a method of facilitating crowd-investing of at least one investor in a venture offered by a crowd-investing server.

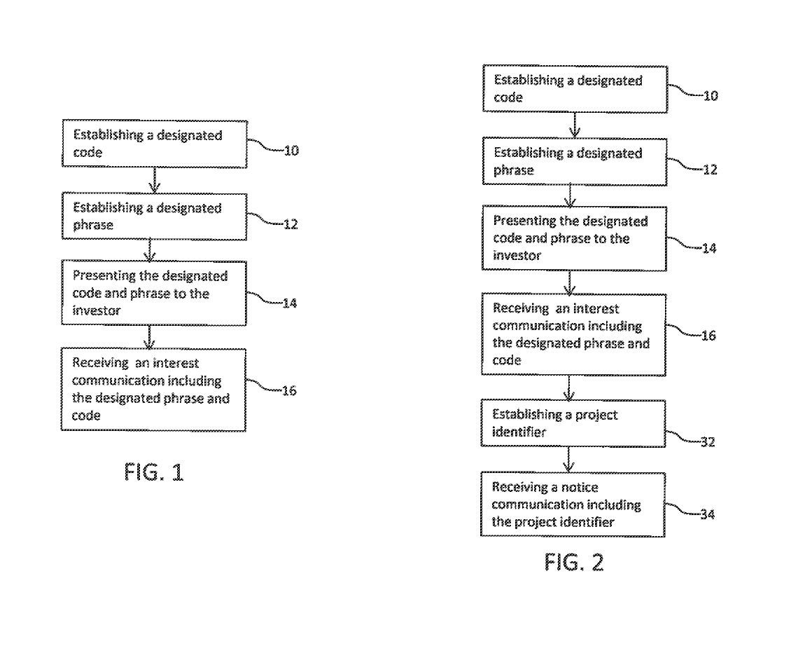

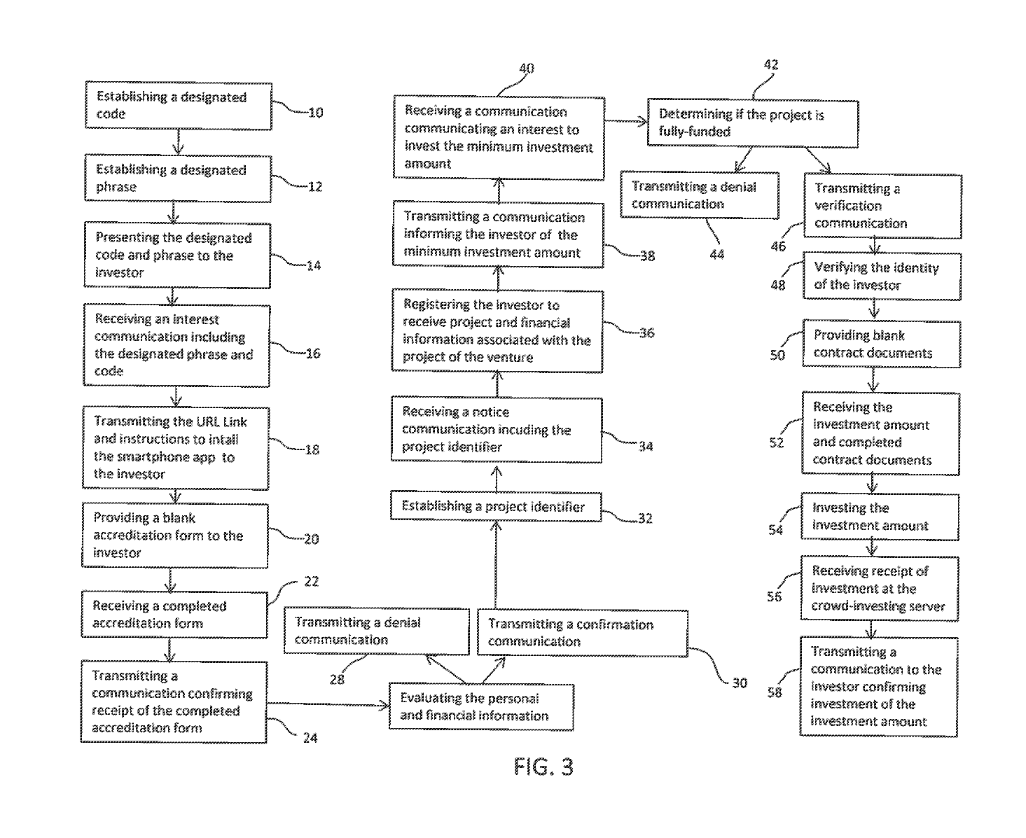

### DESCRIPTION OF THE ENABLING EMBODIMENT

Referring to the Figures, wherein like numerals indicate corresponding parts throughout the several views, a method of facilitating crowd-investing of at least one investor in a venture offered by a crowd-investing server is generally shown.

As will be described in more detail below, the crowd-investor server can include a means, technique, system, or proprietary software that implements unique HTML5 and/or application-based mobile technology and mobile tools to administer and establish secure, intelligently routed, investments sent by a crowd investor to a crowd-investing campaign offered by a venture. The investments can be single and multi-tenant wireless transactions sent, received, transmitted and deposited for purposes related to establishing equity, stocks, bonds, investment transactions or any other kind of financial transaction in order to participate in the crowd-investing campaign. As will also be described in more detail below, a crowd investor can invest in the venture offered by the crowd-investing server by way of mobile phones, mobile applications, landline phones, desktop and laptop computers, tablets, and the like.

The crowd-investing server is a supplement to a venture's unique existing operating system and allows a venture to easily create a secure HTML5 and/or a mobile application mobile enhanced crowd-investing server with a unique URL that includes: mobile tools, crowd-investing hosting, participation and tracking, purchasing securities, making a charitable contribution, transaction management/administration mechanism, engagement and analytics tools—without the need for the venture to input code. The crowd-investing server can preferably function within an existing or new mobile application, website or a plug and play insert code for the code of an existing online capacity to implement unique direct-to-consumer or direct-to-investor transactions. Through the use of unique mobile technology and mobile tools, the crowd-investing server can also facilitate the tracking of all investments made by one or a group of investors through the secure HTML5 web and application-based mobile-enhanced website URL. If an investor so elects, the crowd-investing server can also provide a unique social network offering to the investor, such as by allowing crowd investors to create communities, discussions, and even make suggestions to the crowd-investing server.

The term venture as used herein includes, but is not limited to, any startup company, established company, idea, invention, existing product, charity, any and all online properties, any and all ecommerce transactions, any and all things of value, merchandise, any and all securities, any and all stocks, any and all bonds, currencies of any country, cash of any kind, commodities, health care and consumer staples, REITs, real estate, property, houses, gold, silver, diamonds, precious metals, mutual funds, taxes, individual, musical band, solo artist, designed product, film project, cause, goods of any kind, services of any kind, any and all artistic endeavors, or any and all gathering of monetary funds for any and all purposes. The term electronic communication, as used herein, includes, but is not limited to an e-mail, push notification, in-app message, SMS text message, GSM, SMSC, SkyMail, Short Mail, I-mode, SMTP over TCP/IP, or the like.

The method of facilitating crowd-investing via the crowd-investing server begins with 10 the establishment of a designated code and/or short code, set by the crowd-investing server, at which to receive an interest communication electronically sent from the investor. The interest communication indicates an interest to register and be qualified with the crowd-investing server to invest in at least one venture offered by the crowd-investing server. The interest communication is sent from the investor via a computing device associated with the investor. In the preferred embodiment, the computing device is a smartphone with unique distinguishing features, including but not limited to, a unique associated make, a unique associated model number, a unique associated serial number, unique associated manufacturer, a unique associated phone number, unique and associated geolocation, geofenced and/or geotagging information, and unique associated carrier and/or network, but other computing devices could be used, such as a landline phone, a desktop computer, a laptop computer, tablet or the like, without departing from the scope of the subject disclosure. In a preferred embodiment, the interest communication electronically sent from the investor is a text message, however other electronic communications can be sent without departing from the scope of the subject disclosure. In the preferred embodiment, the designated code is a code and/or short code at which the text message may be received e.g., 78278, but other designated codes, words and/or phrases at which information may be received could also be used, including a standard telephone number, website address, an e-mail address or the like.

The method proceeds by 12 establishing a designated phrase set by the crowd-investing server. The designated phrase is intended to be included in the interest communication for quickly and easily allowing the crowd-investing server to recognize an interest of the investor to register with and be qualified with the crowd-investing server. In other words, the interest communication allows the crowd-investing server to instantaneously flag the investors communicated interest to invest in at least one venture offered by the crowd-investing server. In the preferred embodiment, the designated phrase is the word “invest”, but other phrases could be used, such as another word, phrase, combination of numbers, symbols, and letters, and the like. In other embodiments, the investor can also go to a website, such as www.Textinvesting.com, (or a licensee or subsidiary thereof or the host's unique URL) via a mobile or web browser, or call via mobile phones, mobile applications, regular phones, or send an e-mail, push notification, in-app message, SMS, SMS Textinvesting™, GSM, SMSC, SkyMail, Short Mail, i-mode, SMTP over TCP/IP or the like to a pre-determined destination.

The method proceeds by 14 presenting the designated code and designated phrase to the investor. In the preferred embodiment, the designated code and phrase are presented to the investor via a television broadcast, but other presentation forms could be used such as a newspaper, magazine, newsletter, blogging, e-commerce, website (web or mobile), radio broadcast, telephone campaigns or the like.

In the event the designated code and phrase are presented to the investor via a television broadcast, in an embodiment, the founder(s) of the ventures of interest will have an opportunity to pitch their business vision and ideas personally by way of the television broadcast. At the time of pitching the business/venture, the television broadcast would preferably concurrently display the designated code and designated phrase to its viewers. In the event a television viewer is interested in investing in the business/venture, as will be explained in more detail below, the investor can send a “real-time” text message to the crowd-investing server communicating their interest to crowd-invest. In other words, the crowd-investor's potential investment in the venture offered on the television broadcast is simply a “click” or text message away. As a result, the designated code and designated phrase allow crowd-investors to very simply engage ventures for potential investment. This aspect allows the investor to not only view the television show, but to participate in it by getting involved in funding ventures, voting for ventures, viewing venture associated information in real-time during the broadcast as displayed and presented on the broadcast, or after the broadcast. As explained in further detail below, during or after viewing the show, the investor is also able to access, via their mobile or web computing devices, information pertaining to the ventures presented on the broadcast. Such information may include, but is not limited to, spreadsheets, projections, interviews, press, awards, founder backgrounds and/or resumes, valuations, and evaluations. It is also anticipated that awards may be provided to contestants on the television show in response to having received the most funding from viewers, the fastest funded, the judges choice and/or the viewers' choice during a predetermined period of time, thus adding to the excitement of the entrepreneur's and investor's experience.

Thus, the television broadcast provides a transmedia platform which combines the entertainment and excitement of a reality television contest with the buying urgency of the New York Stock Exchange trading floor to inspire and educate people to be entrepreneurs, foster innovation, benefit ventures seeking investors, and to inspire crowd-investors searching for the next great company. The incorporation of the designated code, designated phrase, and text messaging aspect into the television broadcast increases viewer participation and interest in the television broadcast, and thus is likely to drive up its television ratings.

In another embodiment, telephone, radio, electronic, and other campaigns can be designed to target any specific or non-specific geographic area, including, but not limited to a room, building, studio, store, theatre, church, stadium, arena, venue, defined outside area, neighborhood, town, city, state, country or the entire world and open to national or international and worldwide audiences, all countries, the entire world, the entire universe or a unique individual, any unique areas defined by a geofence, geolocation, geotagging or any specific boundary or border.

If the investor has an interest in qualifying and being registered to invest in ventures offered by the crowd-investing server based on the broadcast or the campaign, the method continues with 16 receiving an interest communication including the designated phrase sent to the designated code from the investor computing device. For example, in the preferred embodiment, the investor sends a text message including the phrase “invest” to the code “78278” to indicate an interest in qualifying and registering with the crowd-investing server. Typically the investor at this point in the method is a “first time” investor. Furthermore, other electronic communication methods such as internet messaging and e-mail could be used to transmit the interest communication without departing from the scope of the subject disclosure.

In response to the crowd-investing server receiving the interest communication, the method proceeds with 18 the crowd-investing server electronically transmitting an electronic communication, such as a text message, to the investor computing device. The electronic communication includes a URL link to a website or designated web and/or mobile property along with instructions explaining how the investor can install a web-base and/or smartphone application (or “opt-in” to the server's or venture's HTML5 mobile website or mobile application) associated with the crowd-investing server. In other words, the investor automatically receives back from the crowd-investing server, on their mobile device, connected device or telephone, an electronic message with a URL, code or instructions to tap or follow to direct a message back to the server or venture. It should be appreciated that as used herein, a smartphone application is installed on a smartphone, and a web application requires a web browser to be displayed thereon. As mentioned, in the preferred embodiment, the electronic communication is transmitted via text message, but other electronic communication methods such as e-mail could be used without departing from the scope of the subject disclosure. The website, the smartphone application, or HTML5 mobile website each facilitate the registration and qualification process of the investor with the crowd-investing server, and, if approved, accredited and/or registered, will allow the investor to view all of the ventures offered by the crowd-investing server and in which the investor could crowd-invest. In other words, upon following the link to the website, mobile website or installing the smartphone application, the investor is opted-in to the crowd-investing server to access crowd-investing information available and presented by the crowd-investing server.

The method proceeds by 20 providing a blank accreditation form to the investor to request personal, financial, and unique phone, wireless device or instrument information thereon from the investor for qualifying the investor to invest in ventures offered by the crowd-investing server. For example, the personal and financial information can include the investors name, address, occupation, education, annual income, adjusted gross income, assets, liabilities, tax information or the like. The unique phone, wireless device, and/or instrument information, which enables the investor to be identified uniquely, can include, but is not limited to, unique distinguishing features including a unique associated make, a unique associated model number, a unique associated serial number, a unique associated manufacturer, a unique associated phone number, a unique and associated geolocation, geofenced and/or geotagging information and unique associated carrier and/or network. The blank accreditation form also includes any and all required legal disclaimers and administrative information required by The JOBS Act.

The method proceeds by 22 receiving a completed accreditation form including the investor personal, financial and unique device-specific information from the investor. The completed accreditation form is electronically transmitted to the crowd-investing server from the investor computing device. The method then proceeds with 24 electronically transmitting a communication to the investor computing device confirming receipt of the completed accreditation form. In the preferred embodiment, the communication is transmitted via text message, but other forms of communication could be used including a message in the smartphone application or a web application, an e-mail, phone call or the like.

After the accreditation form has been received, the method proceeds by 26 evaluating the personal and financial information in relation to a predetermined criteria to determine if the investor is qualified to crowd-invest in current and future ventures offered by the crowd-investing server. In a preferred embodiment, the predetermined criteria and compliance requirements are constructed in accordance with requirements set by the Securities and Exchange Commission (SEC), The JOBS Act, and other relevant investment qualification criteria. The predetermined criteria and compliance requirements allow for small and/or varying amounts of investments by investors in exchange for equity in that venture, the investments otherwise having to go through the SEC or requiring the investor to be accredited as a venture capitalist.

Based on the evaluation of the accreditation form, the method proceeds by either 28 electronically transmitting a denial communication or 30 electronically transmitting a confirmation communication to the investor computing device (e.g., mobile phone). In the preferred embodiment the confirmation and denial communications are transmitted via text message, but other forms of communication could be used including a message in the smartphone application or a web application, e-mail, phone call or the like. The denial communication is transmitted in response to a determination that the investor did not pass the predetermined criteria. The denial communication informs the investor that unfortunately they are not qualified and accredited to invest in ventures offered by the crowd-investing server. The confirmation communication is transmitted in response to a determination that the investor meets the predetermined criteria. The confirmation communication includes a confirmation of accreditation and qualification of the investor to invest in the ventures offered by the crowd-investing server. In accordance with the denial and confirmation communications as described, it should be appreciated that the subject method provides for an improved process of informing an investor of whether they have been approved or denied accreditation to invest in ventures offered by a crowd-investing server.

In further response to a determination that the investor passed the predetermined criteria, the investor is provided unlimited access to the crowd-investing server, allowing the investor to securely research, invest, donate or participate in any future ventures offered by the crowd-investing server. To facilitate access to the crowd-investing server by the investor, the investor is provided access to their own web-based and smartphone web application interface for managing their investments.

The website and smartphone application each include tools that provide for social communication among investors within and outside of a geo-fenced area, searching for ventures offered by the crowd-investing server, storage of information associated with or identified by the investor, streaming video and playing of audio related to ventures offered by the crowd investing server, as well as other capabilities. The website and smartphone application securely coordinate and keep track of all ventures offered by the crowd-investing server, as well as all investments, purchases, payments and transactions associated with the investor via a cloud memory management device. Such transactions may include deposits, withdrawals of currency and the transferring of currency between ventures offered by the crowd-investing server. The website and smartphone application offer easy to follow techniques and instructions for the investor to create security credentials (such as those explained immediately below), and allow the investor to customize the look, feel and functionality of the website and smartphone application.

In an aspect, the investor's unique mobile website will have its own unique URL and will be “free” to the investor upon creation. The mobile website could also have additional tiered functionality that will be offered at various pricing levels to the investor and will be the central hub for all future crowd-investing activities, and any and all financial transactions the investor elects to include within or outside a geofence, geolocation or geotagged area. There will be easy and specific instructions for the investor to imbed an icon or visual representation of their individualized crowd-investing mobile site on their wireless or connected computing device and/or on to their specific operating system for easy and fast access.

In order to provide secure access to the website and smartphone application, each utilizes a unique username and password associated with the investor. Since the subject method includes the transfer of monetary funds, additional security mechanisms can be incorporated into the subject method to ensure that transactions and communications are communicated with the utmost security. These additional security measures may include verifying credentials and/or unique digital files including but not limited to, the investor's phone, wireless device and/or web computing device's unique associated make, the unique associated model number, the unique associated serial number, the unique associated manufacturer, the unique associated phone number, the unique and associated geolocation, geofenced and/or geotagging information, unique associated carrier and/or network, the unique code plus password, the unique URL, unique human biometrics, including but not limited to voice recognition, retina identification, movement recognition, fingerprint recognition, facial recognition, motion sensors behind a facial recognition establishing mechanism and the like. As such, every transaction with the crowd-investing server has the capacity for a unique user choice driven, security based, multi-layered transmission on digital via voice to text to short code, fingerprint, voice and facial recognition and retina technology, and any combination of these security measures may be used in any transaction. Furthermore, any combination of these security measures may be encrypted into all communications associated with the subject method, e.g., these security measures may be encrypted into one or more text messages. The secure electronic transactions and communications used in the subject method advantageously can revolve around and incorporate a plurality of data, audio, and visual image transmissions sent at the same time within the electronic and/or mobile communications. For example, in accordance with the aforementioned features, an investor must submit a unique password with an identifiable investment code, i.e., the designated phrase, to a pre-specified number, i.e., the designated code. In order to maintain the security of the investor, the investor must be verified with a password number that only the investor is aware of. This password number must be provided in order to provide access to the website and/or smartphone application.

The method proceeds with 32 establishing a project identifier that correlates with a project offered by the venture for investment. In the preferred embodiment, the project identifier is a phrase, but could alternatively be any file number, a combination of letters, numbers and symbols associated with project, or the like. After the investor sees, reads, hears, or becomes aware of the venture and its project identifier on television, a mobile device, a connected laptop or desktop computer, radio, magazine, or the like, the method proceeds by 34 receiving a notice communication including the project identifier at the crowd-investing server from the investor computing device which indicates a desire to invest in the project of the venture. In the preferred embodiment, receiving the notice communication from the investor computing device includes receiving a text message which includes the project identifier sent from the investor computing device. Other forms of communicating the project identifier could also be used, including a message in the smartphone application, e-mail or the like.

After receiving the notice communication, the method proceeds with 36 registering the investor with the crowd-investing server to electronically receive and research project and financial information associated with the project of the venture which the investor indicated an interest to invest in. The project and financial information includes at least one minimum investment amount established by the venture that is needed to allow the investor to invest in the project offered by the venture. In other words, there may or may not be multiple choices of different amounts to crowd-invest in the venture, and there may even be a “cap” amount associated with the campaign. However, each of these minimum investment amounts and “cap” amounts will be made clear, as well as all pertinent details at the outset, or beginning of the project by the venture.

The method continues with 38 electronically transmitting a communication to the investor computing device (e.g., a mobile device) informing the investor of the minimum investment amount, and any “cap” amounts”, for investing in the project of interest. In the preferred embodiment, the communication is transmitted via text message, but other forms of communication could be used, including a message in the smartphone application, e-mail or the like. If the investor wishes to invest the minimum investment amount in the project of interest, the method proceeds by 40 receiving an electronic communication sent from the investor computing device to communicate an interest to invest the minimum investment amount into the project.

The method proceeds by 42 determining if the project offered by the venture is fully-funded. Based on this determination, the method continues either by 44 transmitting a denial communication or by 46 transmitting a verification communication from the crowd-investing server to the investor computing device. In the preferred embodiment, the denial and verification communications are transmitted via text message, but other forms of communication could be used, including a message in the smartphone application or web application, e-mail or the like. The denial communication is transmitted to the investor computing device in response to a determination that the project is fully-funded. The denial communication informs the investor that additional investments are not being accepted by the venture because the project is fully-funded. The verification communication is transmitted in response to a determination that the project is not fully-funded and the venture is accepting additional minimum and/or varying amounts of investments. The verification communication also includes investment contract documents for completion by the investor. These contract documents are necessary prior to executing the minimum investment with the venture. Accordingly, the denial and verification communications provide for an improved, fast and simple process of informing the investor that they may or may not invest in the project of the venture.

In response to either the denial or verification communication, the investor will have an opportunity to “opt-in” to a mobile site associated with the project offered by the venture. In other words, even if an investor is denied the opportunity to crowd-invest in the venture, the investor will still have an opportunity to track the future progress of the venture's project and engage with the venture. Ultimately, even if potential crowd-investors are not allowed to invest in a project or venture, by way of “opting-in” to the venture they can become a customer of the venture in the future. For example, the crowd-investing server could provide mobile and online marketplace offers to the “opted-in” crowd-investor allowing them to follow a web-link to the venture. In an aspect, the web-link can present the goods and services associated with the project to the opted-in investor or individual in an easy to buy format.

In further response to a determination that the project has not been fully funded, the method proceeds with 48 verifying the identity of the investor via a security mechanism. As discussed in more detail above, the security mechanism may include any combination of verifying credentials such as codes and/or words, phrases, unique designs, photos, videos, colors, the user's telephone number, unique device information, a unique URL, unique biometrics, unique biochemistry, unique voice of the investor, retina identification, movement recognition, scent recognition, fingerprint recognition and the like. Any combination of these security measures may be encrypted into all communications associated with the subject method. Because of the aforementioned security mechanisms, the subject method provides for an improved, more secure, process of the “act” of making an investment. After the identity of the investor has been verified, the method proceeds by 50 providing blank contract documents to the investor to request information thereon that is necessary to execute the investment transaction sent by the investor.

After the blank contract documents are completed, the method continues with 52 receiving the investment amount and completed contract documents at the crowd-investing server sent from the investor computing device. The investment amount may be received by the crowd-investing server by way of a credit card transaction, checking account number, and the like.

Upon receiving the investment amount and completed contract documents at the crowd-investing server, the method continues with 54 investing the investment amount into the venture. The investment amount may be invested into the venture through a computer-based transaction, with the investment amount electronically deposited into an investment account associated with the venture. The method continues with 56 receiving a receipt at the crowd-investing server from the venture confirming receipt of the investment amount. After the venture confirms receipt of the investment amount, the method proceeds with 58 transmitting a communication from the crowd-investing server to the investor computing device informing the investor that the investment amount was successfully received/deposited with the venture. In the preferred embodiment, the communication is transmitted via text message, but other forms of communication could be used, including a message in the smartphone application or web application, e-mail or the like. In accordance with this electronic transmittal of a communication to the investor informing the investor that the investment was successfully received, the subject method provides for an improved process of informing an investor that their investment transaction was successfully completed.

As mentioned above, regardless of whether it was determined that the project was fully-funded or not, the investor may remain “opted in” to the venture of interest via the website or smartphone application to continue to receive information on the venture of interest. For example, the venture can engage, market to, and further monetizes and/or electronically communicate with crowd-investors as well as those investors whose investments were not accepted, yet elected to stay “opted in” to the project. In an aspect, this engagement occurs through the ventures' use of the mobile technology, mobile and online tools offered by the crowd-investing server. The investor may at any time opt-out of the venture of interest via the website or smartphone application to discontinue receiving information on the venture of interest.

To further incentivize potential and return crowd-investors and to encourage potential and return crowd-investors to “opt-in” to projects offered by ventures, a digital download delivery mechanism is available after investments or inquiries via the interest communication are made. Crowd-investors and users of the crowd-investing server can be required to input information into a data and analytics gathering tool prior to receiving the digital download. Additionally, crowd-investors who demonstrate loyalty to the crowd-investing server through their own investment participation or through the referrals of friends or relatives to the crowd-investing website, mobile website and/or server, could have opportunities to participate in photo/video contests, gamification events, contests, games, raffles, surveys and/or be awarded with physical and/or digital goods, social media communications, VIP access, exclusive digital goods, or opportunities to participate in desired brand, company, individual or product or brand related activities. Crowd-investors who stay “opted-in” and loyal to the crowd-investing server also may have an opportunity to upload and download brand, company, individual or product related digital goods including: music, art, screensavers, ringtones, photographs and videos.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A method of facilitating crowd-investing of at least one investor in a venture offered by a crowd-investing server, said method comprising
receiving an interest communication electronically communicated to the crowd-investing server from an investor computing device associated with the investor indicating an interest to be qualified with the crowd-investing server to invest in the venture offered by the crowd-investing server,
establishing a designated code set by the crowd-investing server at which to receive the interest communication sent from the investor computing device,
establishing a designated phrase set by the crowd-investing server for inclusion in the interest communication to allow the crowd-investing server to automatically recognize an interest of the investor to be qualified with the crowd-investing server,
presenting the designated code and designated phrase to the investor prior to said step of receiving the interest communication,
said step of receiving the interest communication includes receiving the designated phrase sent to the designated code from the investor computing device.

2. The method as set forth in claim 1 wherein said step of receiving an interest communication further includes receiving the designated phrase at the designated code via text message.

3. The method as set forth in claim 1 wherein said step of receiving an interest communication further includes receiving the designated phrase at the designated code via a smartphone application.

4. The method as set forth in claim 1 wherein said step of presenting the designated code and designated phrase includes presenting the designated code and designated phrase via a television broadcast.

5. The method as set forth in claim 1 wherein said step of presenting the designated code and designated phrase includes presenting the designated code and designated phrase via a at least one of a newspaper, a magazine, a newsletter, via blogging, e-commerce, a website, a mobile website, a radio broadcast, or a telephone campaign.

6. The method as set forth in claim 1 further including establishing a project identifier comprising at least one of a file number or a phrase correlated to a project of the venture,
receiving a notice communication at the crowd-investing server from the investor computing device including the project identifier indicating a desire to invest in a specific venture offered by the crowd-investing server.

7. The method as set forth in claim 6 wherein said step of receiving a notice communication from the investor computing device further includes receiving the project identifier via a text message at the crowd-investing server from the investor computing device.

8. The method as set forth in claim 6 wherein said step of receiving a notice communication further includes receiving the project identifier via a message from a smartphone application at the crowd-investing server from the investor computing device.

9. The method as set forth in claim 1 wherein the designated code is a standard telephone number.

10. The method as set forth in claim 1 wherein the designated phrase is the word “invest”.

11. The method as set forth in claim 1 further including determining if the investor meets a predetermined criteria to become accredited for investment in current and future ventures offered by the crowd-investing server.

12. The method as set forth in claim 11 further including providing the investor with access to the crowd-investing server to allow the investor to research the plurality of ventures offered by the crowd-investing server in response to a determination that the investor passed the predetermined criteria.

13. The method as set forth in claim 1 further including transmitting a communication via text message to the investor computer device including a URL link to a website and instructions to install a smartphone application wherein the website and the smartphone application each facilitate the registration and qualification of the investor with the crowd-investing server and allowing the investor to view ventures offered by the crowd-investing server.

14. The method as set forth in claim 1 further including providing a blank accreditation form to the investor to request personal and financial information from the investor for qualifying the investor to invest in ventures offered by the crowd-investing server based on a predetermined criteria constructed in accordance with requirements from the Securities and Exchange Commission.

15. The method as set forth in claim 14 further including receiving a completed accreditation form including the personal and financial information from the investor and electronically transmitted to the crowd-investing server from the investor computing device.

16. The method as set forth in claim 15 further including reviewing the completed accreditation form to determine if the investor meets the predetermined criteria to become accredited for investment in current and future ventures offered by the crowd-investing server.

17. The method as set forth in claim 16 further including electronically transmitting a denial communication via at least one of a text message or the smartphone application to the investor computing device in response to a determination that the investor did not pass the predetermined criteria wherein the denial communication informs the investor that they are not qualified and accredited to invest in ventures offered by the crowd-investing server.

18. The method as set forth in claim 16 further including electronically transmitting a confirmation communication via at least one of a text message or the smartphone application to the investor computing device in response to a determination that the investor meets the predetermined criteria wherein the confirmation communication includes a confirmation of accreditation and qualification of the investor to invest in the ventures offered by the crowd-investing server.

19. The method as set forth in claim 18 further including registering the investor with the crowd-investing server to electronically receive and research project information associated with the plurality of ventures wherein the project and financial information includes at least one minimum investment amount established by the venture for allowing the investor to invest in the project offered by the investor,
electronically transmitting a communication via at least one of a text message or the smartphone application the investor computing device informing the investor of the minimum investment amount for investing in the project of interest,
receiving the investment amount and completed contract at the crowd-investing server from the investor computing device,
investing the investment amount sent by the investor computing device in the project of the venture,
verifying the identity of the investor through a security mechanism prior to said step of investing the investment amount sent by the investor computing device,
wherein said security mechanism is encrypted into a text message sent to the crowd-investing server.

20. A method of facilitating crowd-investing of at least one investor in a venture offered by a crowd-investing server, said method comprising;
receiving an interest communication electronically communicated to the crowd-investing server from an investor computing device associated with the investor indicating an interest to register with and be qualified with the crowd-investing server to invest in at least one venture offered by the crowd-investing server,
electronically transmitting a communication via text message to the investor computing device including a URL link to a website and instructions to install a smartphone application,
the website and the smartphone application each facilitating registration and qualification of the investor and allowing the investor to view ventures offered by the crowd-investing server,
providing a blank accreditation form to the investor to request personal and financial information thereon from the investor for qualifying the investor to invest in ventures offered by the crowd-investing server based on a predetermined criteria constructed in accordance with crowd-investing requirements established by the Securities and Exchange Commission,
receiving a completed accreditation form including the investor personal and financial information of the investor and electronically transmitted to the crowd-investing server from the investor computing device,
electronically transmitting a communication via at least one of a text message or the smartphone application to the investor computing device confirming receipt of the completed accreditation form,
reviewing the completed accreditation form to determine if the investor meets the predetermined criteria to become accredited for investment in current and future ventures offered by the crowd-investing server,
electronically transmitting a denial communication via at least one of a text message or the smartphone application to the investor computing device in response to a determination that the investor did not pass the predetermined criteria,
the denial communication informing the investor that they are not qualified and accredited to invest in ventures offered by the crowd-investing server,
electronically transmitting a confirmation communication via at least one of a text message or the smartphone application to the investor computing device in response to a determination that the investor meets the predetermined criteria,
the confirmation communication including a confirmation of accreditation and qualification of the investor to invest in the ventures offered by the crowd-investing server,
providing the investor with unlimited access to the crowd-investing server to allow the investor to research the plurality of ventures offered by the crowd-investing server in further response to a determination that the investor passed the predetermined criteria,
receiving a notice communication electronically communicated to the crowd-investing server from the investor computing device indicating a desire to invest in one of the plurality of ventures offered by the crowd-investing server,
registering the investor with the crowd-investing server for allowing the investor to electronically receive and research project and financial information associated with the plurality of ventures,
the project and financial information including at least one minimum investment amount established by the venture for allowing the investor to invest in the project offered by the venture,
electronically transmitting a communication via at least one of a text message or the smartphone application to the investor computing device informing the investor of the minimum investment amount associated with the project of interest,
receiving a communication electronically communicated to the crowd-investing server from the investor computing device communicating an interest to invest the minimum investment amount into the project,
determining if the project is fully-funded,
electronically transmitting a denial communication to the investor computing device in response to a determination that the project is fully-funded,
the denial communication informing the investor that additional investments are not being accepted by the venture because the project is fully-funded,
electronically transmitting a verification communication from the crowd-investing server to the investor computing device in response to a determination that the project is not fully-funded and the venture is accepting additional minimum investments,
the verification communication including investment contract documents for completion by the investor prior to execution of the minimum investment with the venture,
receiving the investment amount and completed investment contract documents at the crowd-investing server from the investor computing device,
investing the investment amount sent by the investor computing device in the project of the venture in further response to a determination that the project has not been fully-funded,
verifying the identity of the investor through a security mechanism prior to said step of investing the investment amount sent by the investor computing device,
wherein the security mechanism includes at least one of unique computing device make or a unique computing device model number or a unique computing device serial number or a unique computing device manufacturer or a phone number or a geolocation or geotagging information or a unique network associated with the computing device or a unique code and password or a unique URL or a voice recognizer or a retina recognizer or a movement recognizer or a fingerprint recognizer or a face recognizer,
wherein said security mechanism is encrypted into a text message sent to the crowd-investing server establishing a designated code set by the crowd-investing server at which to receive the interest communication sent from the investor computing device,
wherein the designated code is a standard telephone number,
establishing a designated phrase set by the crowd-investing server and included in the interest communication for recognizing an interest of the investor to register with and be qualified with the crowd-investing server to invest in at least one venture offered by the crowd-investing server,
wherein the designated phrase is the word “invest”,
presenting the designated code and designated phrase to the investor via at least one of a television broadcast or a newspaper or a magazine or a newsletter or a website or a radio broadcast or a telephone prior to said step of receiving an interest communication communicated to the crowd-investing server from the investor computing device,
said step of receiving an interest communication from the investor includes receiving the designated phrase at the designated code via at least one of a text message or a message from the smartphone application at the crowd-investing server from the investor computing device,
establishing a project identifier comprising at least one of a file number or a phrase correlated to the project of the venture,
said step of receiving a notice communication from the investor computing device includes receiving a text message or a message from the smartphone application including the project identifier at the crowd-investing server from the investor computing device indicating a desire to invest in a specific venture offered by the crowd-investing server.
